(19) United States
(12) Patent Application Publication
(10) Pub. No.: US 2021/0146287 A1
(43) Pub. Date: May 20, 2021

(54) FUNCTIONAL INSERT FOR NONWOVEN MATERIALS

(71) Applicant: Zephyros, Inc., Romeo, MI (US)

(72) Inventors: Greg Thompson, Simpsonville, SC (US); Christophe Chaut, Molsheim (FR); Kendall Bush, Macomb, MI (US); Marc Engel, Lingolsheim (FR)

(21) Appl. No.: 17/058,700

(22) PCT Filed: Jun. 25, 2019
(86) PCT No.: PCT/US2019/038967

§ 371 Date: Nov. 25, 2020

Related U.S. Application Data
(60) Provisional application No. 62/689,283, filed on Jun. 25, 2018.

(51) Int. Cl. B01D 39/16; D04H 1/74

(52) U.S. Cl. CPC B01D 39/1623; D04H 1/4374; D04H 1/74

(57) ABSTRACT

The present teachings include a fibrous structure including one or more nonwoven layers comprising a fibrous web layer and one or more functional insert layers for providing additional properties to the material. The one or more of the nonwoven layers and one or more functional insert layers may be lapped together to form a vertically lapped structure. The present teachings also include a method of forming the fibrous structure.

### FIELD

The present teachings relate generally to a composite material and methods of forming the composite material, in particular a composite material having a functional insert layer.

### BACKGROUND

Nonwoven materials are used in a variety of applications. Some nonwoven materials are desirable for their lightweight structure, acoustic performance, filtration abilities, insulation capabilities, and the like. The process of making these nonwoven materials may be very specific for the end use. These specific processes may make tuning or changing the nonwoven materials difficult. Furthermore, if nonwoven materials only provide one of the desired functions, multiple components are necessary to achieve each of the desired functions. For example, multiple materials would be needed to provide acoustic absorption and filtration. In traditional filtration media forming processes, additional steps are required for pleating the media.

In particular, nonwoven materials may be used in filtration. However, current filters must take into account certain characteristics, such as pressure drop, pleat stability, particle filtration, aging stability, air quality monitoring, odor control, carbon sealing, and filter framing, for example. Existing filters experience varying degrees of success with each, but industry is still seeking to make improvements in these areas and others.

Pressure drop, the difference in air pressure on one side of the filter versus the other side of the filter, is a concern. When pressure drop is excessive, airflow through the filter is restricted, resulting in decreased ventilation or necessitating a more powerful fan motor to compensate. Existing filters, such as combi-filters or those that contain activated carbon, show a higher pressure drop than basic filters because the increased media thickness allows for fewer pleats in the same space. This reduces the available surface area. Pressure drop is compensated by using media with lower filtration efficiency to meet regulations, such as windscreen demist regulations.

These combi-filters also must be sealed at the perimeter to avoid the loss of activated carbon dust. Sealing either requires a four-sided frame or a hot-seal process when cutting media ends. This adds additional pieces or steps to the process.

Conventional filters are pleated. This pleated media is limited in height due to pleat instability upon exceeding a particular height, thereby requiring separate support. For example, many conventional filters are limited to a pleat height of about 30 mm to about 35 mm. Current filters require at least two sides to be framed to provide stiffness across the pleats. The framing also seeks to prevent air leakage out of the ends of the pleats. This frame must be separately manufactured and bonded to the pleated media, again adding parts and steps to the process.

The materials forming the filters are also a concern. Certain types of fibers used in filters, such as meltblown polypropylene fibers, have to be somewhat coarse, leading to filtration and efficiency issues, or compressed to support pleat stability, leading to pressure drop issues.

Current existing filtration media typically uses fibers having diameters ranging from about 0.7 micrometers to about 3 micrometers to mechanically trap large particles. Electrostatic charging of these fibers is often used to attract and capture smaller particles. However, there are still issues with capturing these smaller particles, as filtration efficiency can be less than 50% for particles having a diameter of about 0.1 micrometers to about 0.3 micrometers. In addition, electrostatic charge on current media fibers degrades with environmental exposure, resulting in much lower fine particle filtration efficiency after a few months in service. In attempting to trap smaller particles, nanofibers forming the filters have been tried; however, they generally become blocked by larger particles, thereby increasing the pressure drop too quickly.

Current filters, such as those in North America and Europe, typically have a two year design life, determined by pressure drop and dust holding capacity specifications. Over this lifetime, bacteria can build up on the dust in the filter, creating an unpleasant odor. This can be particularly troublesome in vehicles. Additionally, with the growth of shared mobility, there is also a need for removing interior odor from previous passengers. There is also the desire to increase filter life to the equivalent of four years to reduce filter replacement cost.

Air quality monitoring is becoming important among vehicle manufacturers, for example. These manufacturers would like to utilize air quality sensor technology to show the interior versus exterior air quality. Current filters using electrostatically charged fibers, however, would show a decrease in performance over the first months, which would be unacceptable by the manufacturers, and may cause unnecessary or premature filter replacements.

Therefore, industry is constantly seeking new ways of tuning nonwoven materials to achieve desired properties, new methods of making these nonwoven materials, and new ways of incorporating other materials into the nonwoven structures. Industry is also seeking new materials and methods of forming these materials that can serve multiple functions, such as filtration, absorption (e.g., acoustic and/or moisture), resilience, insulation, and the like. Industry is seeking a filter with a reduced pressure drop as compared with traditional filters, materials having pleat stability, the ability to have a filter of increased height (e.g., not limited by pleat stability), a material that achieves improved particle filtration, including filtration of fine particles, a material that provides filtration aging stability, a material that avoids the need for electrostatic charge for achieving filtration, a material that provides improved odor control, a material that is more easily sealed or framed, or a combination thereof. Industry is also seeking simplified methods of forming these materials.

### SUMMARY

The present teachings meet one or more of the above needs by the improved article and methods described herein. The present teachings provide a fibrous structure or composite material, where the combination of layers and materials thereof yield unique properties, such as filtration, structural properties, sound or moisture absorption, repellence, temperature resistance, reactivity, activatability, and the like. The present teachings also provide a method of creating such a fibrous structure, where the insert may be selected based on the desired properties or applications.

The present teachings include a fibrous structure including one or more nonwoven layers comprising a fibrous web layer and one or more functional insert layers for providing additional properties to the material. The one or more of the nonwoven layers and one or more functional insert layers may be lapped together to form a vertically lapped structure. One or more of the nonwoven layers may be a carded web formed from a carding process. The functional insert layer may be a continuous sheet of material prior to lapping. The functional insert layer may be sandwiched between two nonwoven layers, and wherein the functional insert layer and two nonwoven layers are lapped together to form a single vertically lapped structure. The functional insert layer may be a filtration media insert. The functional insert layer may be a material for providing cushioning or resilience to the fibrous structure. The functional insert layer may be a low melt or thermoset material to allow the layer to be molded. The functional insert layer may be an expandable material. The functional insert layer may be a conductive material. The functional insert layer may be a superabsorbent material (e.g., for absorbing chemicals, oil, water, or other liquids). The functional insert layer may be a film or foil. The film or foil may be perforated and/or selectively permeable by design. The functional insert layer may be a membrane layer for blocking moisture and/or controlling a rate of moisture transmission. The functional insert layer, one or more fibrous layers, or both may include adsorptive materials (e.g., active carbon). The functional insert layer may be an acoustic layer. The functional insert layer, one or more other layers, or the fibrous structure as a whole, may enable absorption (e.g., acoustic, fluid), cushioning, wicking of moisture, or a combination thereof. The functional insert layer, one or more other layers, or the fibrous structure as a whole may include a fire retardant material. The functional insert layer may be an intumescent material. The fibrous structure may be thermoformable to shape the fibrous structure into a three-dimensional shape. The fibrous structure may include one or more films, facings, scrims, skins, fabrics, or a combination thereof laminated to one or more sides of the vertically lapped structure. The fibrous structure may be free of a separate frame assembly. A frame may be integrally formed with the fibrous structure. A frame may be formed to seal the fibrous structure. The frame may be formed by hot compressing edges of the fibrous structure and positioning the edges (e.g., folding) to form side walls. The fibrous structure may include one or more components for imparting antimicrobial properties. The fibrous structure may provide filtration without electrostatic charging. The fibrous structure may have a density gradient from one surface toward an opposing surface. Larger particles may be trapped at the one surface, and smaller particles may be trapped toward the opposing surface. The present teachings also include two or more nonwoven material layers comprising a fibrous web layer.

The present teachings also include a method of forming a fibrous structure. The method may include carding fibers to produce a fibrous web; providing a continuous functional insert layer; and introducing one or more fibrous webs and one or more functional insert layers into a lapping machine. The method may form a vertically lapped fibrous structure. The method may include a step of heating the vertically lapped fibrous structure in an oven. The method may include a step of laminating the vertically lapped fibrous structure.

The present teachings therefore may provide a material and method of making the material for achieving desired properties by employing a functional insert material that undergoes a lapping process with one or more additional layers.

### DESCRIPTION OF THE DRAWINGS

FIG. 1 is an exemplary method of forming a fibrous structure or composite material in accordance with the present teachings.

FIG. 2 is an exemplary illustration of forming a fibrous structure or composite material in accordance with the present teachings.

FIG. 3 is an exemplary fibrous structure or composite material in accordance with the present teachings.

FIG. 4 is an exemplary fibrous structure or composite material that includes a vertically lapped fibrous structure that has undergone a second vertical lapping process.

FIG. 5 is an exemplary fibrous structure or composite material that includes a facing layer.

FIG. 6 is an exemplary fibrous structure or composite material that has been sliced to produce two fibrous structures or composite materials.

FIG. 7 illustrates filtration of particles through a fibrous structure or composite material.

FIG. 8A illustrates an exemplary fibrous structure or composite material.

FIGS. 8B and 8C illustrate exemplary methods of compressing the edges of the material of FIG. 8A.

FIG. 8D illustrates the structure of FIG. 8B or FIG. 8C, where the compressed edges form side walls.

FIG. 9 illustrates compressing an exemplary fibrous structure or composite material in the length direction.

FIG. 10A illustrates an exemplary fibrous structure or composite material with no lengthwise compression.

FIG. 10B illustrates an exemplary fibrous structure or composite material with partial lengthwise compression.

FIG. 10C illustrates an exemplary fibrous structure or composite material with high lengthwise compression.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings envision a fibrous structure having multiple layers. The present teachings also envision a method of forming the fibrous structure having multiple layers. The layers may be selected to enable or tune the fibrous structure to achieve desired properties or functions. The fibrous structure as described herein may, for example, find use as filtration materials (e.g., selective filtration, surface and/or depth filtration, gradient style physical filtration, chemical selective filtration), insulation materials, structural materials, acoustic absorption materials, performance cushioning materials, wicking and/or drying materials, and the like. The fibrous structure as described herein may have a wide range of applications, such as in aviation applications, automotive applications, generator set engine compartments, commercial vehicle engines, in-cab areas, construction equipment, agriculture equipment, architectural applications, flooring, floormat underayments (e.g., generally flat and/or molded into three dimensional shapes), performance cushioning, and even heating, ventilating and air conditioning (HVAC) applications. These materials may be used for filtration, such as hot gas filtration. These materials may be used for machinery and equipment insulation, motor vehicle insulation, domestic appliance insulation, dishwashers, and commercial wall and ceiling panels. The materials may be used as in-tire acoustic absorbers, which may be used to decrease noise generated by a tire. The materials may be used in an engine cavity of a vehicle, on the inner and/or outer dash panels, or under the carpeting in the cabin, for example, for providing acoustic absorption, insulation, structure, and the like. The materials may provide sound absorption, compression resiliency, stiffness, structural properties, and/or protection (e.g., to an item around which the material is located). The material may also serve as a sound attenuation material in an aircraft or a vehicle, attenuating sound originating from outside a cabin and propagating toward the inside of the cabin. The materials as disclosed herein may be useful for aircrafts, such as primary insulation, or interior components of an aircraft, such as the seat cushions. The fibrous structure may be used for acoustic and/or thermal insulation, for providing compression resistance, for providing a material that reduces or eliminates the possibility of mold or mildew therein. The fibrous structure may provide long-term structure stability for long-term acoustic and/or thermal performance. The fibrous structure may provide long-term resistance to humid environments or may be able to withstand temperature and humidity variations and fluctuations. The fibrous structure may be used in performance cushioning applications, to provide wicking, absorption, quick drying, comfort, cushioning, odor absorption and/or prevention, the like, or a combination thereof. Exemplary applications include sports padding, helmets, sports shoes, bra cups, clothing, and the like.

The present teachings also contemplate a process that enables in-line incorporation of layers (e.g., one or more fibrous layers, such as a carded layer, and one or more functional insert layers). The process may include in-line pleating (e.g., a lapping process, such as vertical lapping). The process may enable the creation of a unique structure to achieve desired properties and to be used in particular applications. For example, the unique structure may be used for filtration formed from a method that is different from existing filtration forming processes. The unique structure may provide performance cushioning alone or in combination with other properties.

The fibrous structure may include one or more layers. The fibrous structure of the present teachings may include two or more layers. The fibrous structure may include the fibrous web layer and one or more additional layers, such as a functional insert layer. The fibrous structure may include two or more fibrous web layers. One or more layers may be a carded web. One or more layers may be a functional insert material. Layers may be lapped to form the fibrous structure. For example, two or more layers may be stacked and undergo a vertical lapping process to create a fibrous structure. Each layer may be different or unique. For example, each fibrous web layer may be different. Each fibrous web layer may be the same. As another example, the fibrous structure may include two or more functional insert layers. Two or more of the functional insert layers may be the same. Two or more of the functional insert layers may be different.

The fibrous structure may also include one or more additional layers, such as a scrim, facing, backing, film, fabric, foil, mesh, adhesive, or the like. The fibrous structure may have a plurality of different layers. For example, the layers may have different fibers, fiber lengths, thicknesses, densities, pore sizes, air flow resistances, treatments, melting and/or softening points, and the like. The layers may be selected to provide a desired function or desired properties to the fibrous structure. For example, one or more layers may act as a fine particle or surface filter, while another layer may act as a depth or large particle filter, thereby acting as a filtration gradient. In another example, the layers may create a multi-density structure or multi-impedance structure for amplifying acoustic performance.

The fibrous structure of the present teachings may include one or more layers formed into a web. For example, one or more of the fibrous web layers may be formed by a carding process. The resulting layer, after carding, may be a carded web. The web may be formed by an air laying process or any other process capable of forming a fibrous layer that is able to be lapped. The carded webs may be formed from fibers selected for achieving desired properties.

The material fibers that make up one or more layers of the fibrous structure (e.g., a fibrous web layer, a functional insert layer, or combination thereof) may be chosen based on considerations such as temperature resistance, desired thermal conductivity, stiffness, resiliency, cost, desired resistance to long-term humidity exposure, fiber denier, fiber geometry, or the like. The materials forming one or more layers of the fibrous structure may be a blend of fibers. Any of the fibers selected for the one or more layers of the fibrous structure may be capable of being carded and lapped into a three-dimensional structure. Fibers of differing lengths and/or deniers may be combined to provide desired properties, such as filtration, insulation, and/or acoustic properties. The fiber length may vary depending on the application; the filtration being performed (thereby impacting pore size); the temperatures to which the fibrous structure is to be exposed; the insulation properties desired; the acoustic properties desired; the type, dimensions and/or properties of the fibrous material (e.g., density, porosity, desired air flow resistance, thickness, size, shape, and the like of the fibrous web layer and/or any other layers of the fibrous structure); or any combination thereof. The addition of shorter fibers, alone or in combination with longer fibers, may provide for more effective packing of the fibers, which may allow pore size to be more readily controlled in order to achieve desirable characteristics (e.g., acoustic and/or insulation characteristics).

The fibrous web layer may include natural or synthetic fibers. The fibrous web layer may include inorganic fibers. Suitable fibers may include cotton, jute, wool, cellulose, glass, silica-based, ceramic fibers, or any combination thereof. Suitable synthetic fibers may include polyester, polypropylene, polyethylene, Nylon, aramid, imide, acrylate fibers, or combination thereof. The fibrous web layer material may comprise polyester fibers, such as polybutylene terephthalate (PBT), polyethylene terephthalate (PET), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), polyethersulfone (PES), or other polymeric fibers. The fibers may be selected for their melting and/or softening temperatures. The fibers may be 100% virgin fibers, or may contain fibers regenerated from postconsumer waste (for example, up to about 90% fibers regenerated from postconsumer waste or even up to 100% fibers regenerated from postconsumer waste).

The fibrous web layer, or any other layer of the fibrous structure, may be able to pull or push moisture through the layer may be, at least in part, due to the geometries of the fibers. The fibers may have a cross-section that is substantially circular or rounded. The fibers may have a cross-section that has one or more curved portions. The fibers may have a cross-section that is generally oval or elliptical. The fibers may have a cross-section that is non-circular. Such non-circular cross-sections may create additional tubes or capillaries within which the moisture can be transferred. For example, the fibers may have geometries with a multi-lobal cross-section (e.g., having 3 lobes or more, having 4 lobes or more, or having 10 lobes or more). The fibers may have a cross-section with deep grooves. The fibers may have a substantially “Y”-shaped cross-section. The fibers may have a polygonal cross-section (e.g., triangular, square, rectangular, hexagonal, and the like). The fibers may have a star shaped cross-section. The fibers may be serrated. The fibers may have one or more branched structures extending therefrom. The fibers may be fibrillated. The fibers may have a cross-section that is a nonuniform shape, kidney bean shape, dog bone shape, freeform shape, organic shape, amorphous shape, or a combination thereof. The fibers may be substantially straight or linear, hooked, bent, irregularly shaped (e.g., no uniform shape), or a combination thereof. The fibers may include one or more voids extending through a length or thickness of the fibers. The fibers may have a substantially hollow shape. The fibers may be generally solid. The shape of the fibers may define capillaries or channels through which moisture can travel (e.g., from one side of the fibrous layer to an opposing side of the fibrous layer).

The fibers may have a linear mass density of about 0.25 denier or greater, about 0.5 denier or greater, or about 1 denier or greater. The fibers may be about 150 denier or less, about 120 denier or less, or about 100 denier or less. Certain layers may have an average denier of fibers that is higher than other layers. The average denier may depend upon the fibers used. For example, a layer having natural fibers may have an average denier of about 100 denier±about 20 denier. The fibers may have a staple length of about 0.5 millimeters or greater, about 1.5 millimeters or greater, or even about 70 millimeters or greater (e.g., for carded fibrous webs). Fibers within the layer may have a length of about 300 millimeters or less, about 250 millimeters or less, or about 200 millimeters or less. For example, the length of the fibers may be about 30 millimeters or greater and/or about 65 millimeters or less, with an average or common length of about 50 or 51 millimeters staple length, or any length typical of those used in fiber carding processes. Fiber lengths may vary within a layer. For example, a layer may have fibers ranging from about 1 mm to about 120 mm. The length of the fibers used may depend on the processing to form the layer. For example, a carded and/or needle punched layer may require fibers of a certain length (e.g., at least some of the fibers having a length of about 30 mm or longer).

Short fibers may be used. For example, some or all of the fibers may be a powder-like consistency (e.g., with a fiber length of about 0.25 mm or more, about 0.5 mm or more, or about 1 mm or more; about 5 mm or less, about 4 mm or less, or about 3 mm or less). Fibers of differing lengths may be combined to form a fibrous web layer or other layer of the fibrous structure. The fiber length may vary depending on the application, the properties desired, dimensions and/or properties of the material (e.g., density, porosity, desired air flow resistance, thickness, size, shape, and the like of the layer), or any combination thereof. Again, more effective packing of the shorter fibers may allow pore size to be more readily controlled in order to achieve desirable acoustic characteristics, air flow characteristics, or both. In some applications, the use of shorter fibers, or the use of a combination of fibers, may have advantages for forming a material that exhibits acoustic absorption properties. The selected air flow resistivity achieved using short fibers may be significantly higher than the air flow resistivity of a conventional nonwoven material comprising substantially only conventional staple fibers having a long length of, for example, from at least about 30 mm and less than about 100 mm. Without being limited by theory, it is believed that this unexpected increase in air flow resistance may be attained as a result of the short fibers being able to pack more efficiently (e.g., more densely) in the nonwoven material than long fibers. The shorter length may reduce the degree of disorder in the packing of the fibers as they are dispersed onto a surface, such as a conveyor, or into a preformed web during production. The more ordered packing of the fibers in the material may in turn lead to an increase in the air flow resistivity. In particular, the improvement in fiber packing may achieve a reduced interstitial space in between fibers of the nonwoven material to create a labyrinthine structure that forms a tortuous path for air flow through the material, thus providing a selected air flow resistance, and/or selected air flow resistivity. Accordingly, it may be possible to produce comparatively lightweight nonwoven materials without unacceptably sacrificing performance.

One or more fibrous web layers (or any other layer of the fibrous structure) may include a binder or binder fibers. Binder may be present in the fibrous web layer in an amount of about 40 percent by weight or less, about 30 percent by weight or less, about 25 percent by weight or less, or about 15 percent by weight or less. The binder may be present in an amount of about 1 percent by weight or greater, about 3 percent by weight or greater, or about 5 percent by weight or greater. The fibrous web layer may be substantially free of binder. The fibrous web layer may be entirely free of binder. While referred to herein as fibers, it is also contemplated that the binder could be generally powder-like (e.g., with a fiber length of about 3 millimeters or less, or about 2 millimeters or less, or even smaller, such as about 20 microns or greater, about 40 microns or greater, about 100 microns or greater, about 200 microns or greater, or about 500 microns or greater), spherical, or any shape capable of being received within interstitial spaces between other fibers and capable of binding the fibrous web layer together. The binder may have a softening and/or melting temperature of about 180° C. or greater, about 200° C. or greater, about 225° C. or greater, about 230° C. or greater, or even about 250° C. or greater. The fibers may be high-temperature thermoplastic materials. The fibers may include one or more of polyamideimide (PAI); high-performance polyamide (HPPA), such as Nylons; polyimide (PI); polyketone; polysulfone derivatives; polycyclohexane dimethyl-terephthalate (PCT); fluoropolymers; polyetherimide (PEI); polybenzimidazole (PBI); polyethylene terephthalate (PET); polybutylene terephthalate (PBT); polyphenylene sulfide; syndiotactic polystyrene; polyetherether ketone (PEEK); polyphenylene sulfide (PPS), silica-based binder systems; and the like. The fibrous web layer may include polyacrylate and/or epoxy (e.g., thermoset and/or thermoplastic type) fibers. The fibrous web layer may include a multi-binder system. The fibrous web layer may include one or more sacrificial binder materials and/or binder materials having a lower melting temperature than other fibers. The fibrous web layer may include binder materials that are formulated to achieve or impact desired characteristics, such as flame retardance or super absorbance.

The fibrous web layer (or any other layer of the fibrous structure) may include a plurality of bi-component fibers. The bi-component fibers may act as a binder within the fibrous web layer. The bi-component fibers may be a thermoplastic lower melt bi-component fiber. The bi-component fibers may have a lower melting temperature than the other fibers within the mixture. The bi-component fiber may be of aflame retardant type (e.g., formed from or including flame retardant polyester). The bi-component fibers may enable the fibrous web layer to be air laid or mechanically carded, lapped, and fused in space as a network so that the material may have structure and body and can be handled, laminated, fabricated, installed as a cut or molded part, or the like to provide insulation properties, acoustic absorption, structural properties, filtration properties, fire retardant properties, smoke retardant properties, low toxicity, or a combination thereof. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers. The temperature to which the fibrous web layer (or other layer of the fibrous structure) is heated to soften the sheath material of the bi-component may depend upon the physical properties of the sheath material. Some fibers or parts of the fibers (e.g., the sheath) may be crystalline, or partially crystalline. Some fibers or parts of the fibers (e.g., the sheath) may be amorphous.

For a polyethylene or polypropylene sheath, for example, the temperature may be about 140 degrees C. or greater, about 150 degrees C. or greater, or about 160 degrees C. or greater. The temperature may be about 220 degrees C. or less, about 210 degrees C. or less, or about 200 degrees C. or less. Bi-component fibers having a polyethylene terephthalate (PET) sheath or a polybutylene terephthalate (PBT) sheath, for example, may melt at about 180 degrees C. to about 240 degrees C. (e.g., about 230 degrees C.). The bi-component fibers may be formed of short lengths chopped from extruded bi-component fibers. The bi-component fibers may have a sheath-to-core ratio (in cross-sectional area) of about 15% or more, about 20% or more, or about 25% or more. The bi-component fibers may have a sheath-to-core ratio of about 50% or less, about 40% or less, or about 35% or less.

The fibers may have or may provide improved thermal insulation properties. The fibers may have relatively low thermal conductivity. The fibers may have geometries that are non-circular or non-cylindrical (e.g., to alter convective flows around the fiber to reduce convective heat transfer effects within the three-dimensional structure). The fibrous web layer may include or contain engineered aerogel structures to impart additional thermal insulating benefits. The fibrous web layer may include or be enriched with pyrolized organic bamboo additives. Some fibers may be sacrificial upon exposure to certain temperatures. For example, if the fibrous web layer is exposed to a temperature of about 250° C. or greater, some of the fibers may volatilize away.

The fibers forming the fibrous web layer include an inorganic material. The inorganic material may be any material capable of withstanding temperatures of about 250° C. or greater, about 500° C. or greater, about 750° C. or greater, about 1000° C. or greater. The inorganic material may be a material capable of withstanding temperatures up to about 1200° C. (e.g., up to about 1150° C.). The inorganic fibers may have a limiting oxygen index (LOI) via ASTM D2836 or ISO 4589-2 for example that is indicative of low flame or smoke. The LOI of the inorganic fibers may be higher than the LOI of standard binder fibers. For example, the LOI of standard PET bicomponent fibers may be about 20 to about 23. Therefore, the LOI of the inorganic fibers may be about 23 or greater. For example, the LOI may be about 100. The inorganic fibers may have an LOI that is about 25 or greater. The inorganic fibers may be present in the fibrous web layer in an amount of about 60 percent by weight or greater, about 70 percent by weight or greater, about 80 percent by weight or greater, or about 90 percent by weight or greater. The inorganic fibers may be present in the fibrous web layer in an amount of about 100 percent by weight or less. The inorganic fibers may be selected based on a desired stiffness. The inorganic fibers may be crimped, non-crimped, or a combination thereof. Non-crimped organic fibers may be used when a fiber with a larger bending modulus (or higher stiffness) is desired. The modulus of the inorganic fiber may determine the size of the loops when the lapped fibrous structure is formed. Where a fiber is needed to bend more easily, a crimped fiber may be used. The inorganic fibers may be ceramic fibers, glass fibers, mineral-based fibers, or a combination thereof. Ceramic fibers may be formed from polysilicic acid (e.g., Sialoxol or Sialoxid), or derivatives of such. For example, the inorganic fibers may be based on an amorphous aluminum oxide containing polysilicic acid. Siloxane, silane, and/or silanol may be added or reacted into the fibrous web layer to impart additional functionality. These modifiers could include carbon-containing components.

Any inorganic fibers of the fibrous web layer may have an average linear mass density of about 0.4 denier or greater, about 0.6 denier or greater, or about 0.8 denier or greater. The inorganic fibers of the fibrous web layer may have an average linear mass density of about 2.0 denier or less, about 1.7 denier or less, or about 1.5 denier or less. Other fibers of the fibrous web layer (e.g., bicomponent binder) may have an average linear mass density of about 1 denier or greater, about 1.5 denier or greater, or about 2 denier or greater. Other fibers of the fibrous web layer (e.g., bicomponent binder) may have an average linear mass density of about 20 denier or less, about 17 denier or less, or about 15 denier or less. The inorganic fibers of the fibrous web layer may have a length of about 20 mm or greater, about 27 mm or greater, or about 34 mm or greater. The inorganic fibers of the fibrous web layer may have a length of about 200 mm or less, about 150 mm or less, or about 130 mm or less. A combination of fibers having varying lengths may be used. For example, a combination of about 67 mm and about 100 mm lengths may be used. Varying lengths may be advantageous in some instances, as there may be natural cohesion of the fibers due to the length difference of the fibers, the type of fibers, or both. The blend of fibers of the fibrous web layer may have an average denier size of about 1 denier or greater, about 5 denier or greater, or about 6 denier or greater. The blend of fibers of the fibrous web layer may have an average denier size of about 10 denier or less, about 8 denier or less, or about 7 denier or less. For example, the average denier size may be about 6.9 denier.

The fibers, or at least a portion of the fibers, may have high infrared reflectance or low emissivity. At least some of the fibers may be metallized to provide infrared (IR) radiant heat reflection. To provide heat reflective properties to and/or protect the fibrous web layer, the fibers may be metalized. For example, fibers may be aluminized. The fibers themselves may be infrared reflective (e.g., so that an additional metallization or aluminization step may not be necessary). Metallization or aluminization processes can be performed by depositing metal atoms onto the fibers. As an example, aluminization may be established by applying a layer of aluminum atoms to the surface of fibers. Metalizing may be performed prior to the application of any additional layers to the fibrous web layer. It is contemplated that other layers of the fibrous structure may include metallized fibers in addition to, or instead of, having metallized fibers within the fibrous web layer.

The metallization may provide a desired reflectivity or emissivity. The metallized fibers may be about 50% IR reflective or more, about 65% IR reflective or more, or about 80% IR reflective or more. The metallized fibers may be about 100% IR reflective or less, about 99% IR reflective or less, or about 98% IR reflective or less. For example, the emissivity range may be about 0.01 or more or about 0.20 or less, or 99% to about 80% IR reflective, respectively. Emissivity may change over time as oil, dirt, degradation, and the like may impact the fibers in the application.

Other coatings may be applied to the fibers, metallized or not, to achieve desired properties. Oleophobic and/or hydrophobic treatments may be added. Flame retardants may be added. A corrosion resistant coating may be applied to the metalized fibers to reduce or protect the metal (e.g., aluminum) from oxidizing and/or losing reflectivity. IR reflective coatings not based on metallization technology may be added.

The fibers of the fibrous web layer may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation. Any, a portion, or all of the fibers used in the matrix could be of the low flame and/or smoke emitting type (e.g., for compliance with flame and smoke standards for transportation). Powders or liquids may be incorporated into the matrix that impart additional properties, such as binding, fire/smoke retarding intumescent, expanding polymers that work under heat, induction or radiation, which improves acoustic, physical, thermal, and fire properties.

Fibers may be run through a carding process to form a web. This web may then be lapped with additional layers of the fibrous structure, such as one or more functional insert layers to form a lapped structure (e.g., vertically lapped structure).

While the above discussion pertains to one or more fibrous web layers of the fibrous structure, it is contemplated that any of the materials or fibers may also be employed in the one or more functional insert layers or any other layer of the fibrous structure.

The fibrous structure may include one or more functional insert layers. A functional insert layer may be selected based on the desired properties of the fibrous structure. A functional insert layer may be a generally continuous layer. A functional insert layer may be positioned adjacent to a fibrous web layer (e.g., a carded layer). A functional insert layer may be sandwiched between two fibrous web layers (e.g., carded layers). A functional insert layer may be generally coextensive with a fibrous web layer (e.g., prior to lapping). A functional insert layer may cover or be attached to only a portion of a side of the fibrous web layer (e.g., prior to lapping). The functional insert layer may be formed from nonwoven fibers. The functional insert layer may be formed by one or more nonwoven processes including, for example, opening fibers, blending fibers, carding, lapping, air laying, mechanical formation, or a combination thereof. The functional insert layer may thus be a nonwoven structure. The functional insert may be a woven structure. The functional insert layer may be a mesh, film, foil, adhesive, activatable material, expandable material, elastic material, polymeric material, the like, or a combination thereof. The functional insert layer may be formed of any of the fibers discussed with respect to the fibrous web layers (e.g., carded web layers). The functional insert layer may be porous. The functional insert layer may be nonporous or solid. The functional insert layer may be formed of one or more layers.

A functional insert layer may be used (e.g., in conjunction with other layers to form a fibrous structure) in filtration applications. For example, it may be desirable to achieve fluid (e.g., liquid or gas) filtration, such as of water or air. The functional insert layer (e.g., in conjunction with other layers of the fibrous structure) may act to collect unwanted particles from a fluid. The functional insert layer, in conjunction with other layers forming the fibrous structure, may be used for filtration of sound, such as by attenuating the level of sound from sources of vibration. The fibrous structure may act as a low-pass filter, a high-pass filter, or both. The layer may be a filtration media insert. The functional insert layer may be sufficiently porous to trap undesired particles, while allowing a fluid to pass through. The functional insert layer may act to filter physical particles. The functional insert layer may function to filter chemicals (e.g., molecules) in a fluid (e.g., in a gaseous or liquid/vapor state). It is also contemplated that the functional insert layer may function to improve the bursting strength of the filter media. The functional insert layer, in conjunction with other layers of the fibrous structure, such as the one or more nonwoven layers lapped with the functional insert layer, may act as a filtration gradient with high surface area. Gradients may be segmented into localized areas. Such segmentation may be possible due to the lapped structure (e.g., vertically lapped) of the fibrous structure. One or more layers of the fibrous insert may be a depth or large particle filter. One or more layers of the fibrous insert may be a fine particle or surface filter. Therefore, the fibrous insert layer may be a depth filter or a surface filter. The fibrous insert layer may be a fine particle filter or a large particle filter. The functional insert layer may include or be formed from one or more adsorptive materials. For example, the functional insert layer may include or be formed from active carbon. The active carbon (or other adsorptive material) may function to capture certain types of volatile organic compounds. The functional insert layer may be charged. The functional insert layer may be electrostatically charged. The functional insert layer may be a nanofiber scrim and/or a membrane on a carrier. The functional insert layer may be a meltblown or microfiber layer. The functional insert layer may act as a carrier. Particulate matter may be embedded in or present on the surface of the carrier. The particulate matter may, for example, absorb chemicals and/or reinforce the structure. The functional insert layer may be a microperforated film, a microporous film, or both. The functional insert layer may be organic, inorganic, or a combination thereof. The functional insert layer may include materials that are flame, smoke, and toxicity retardant and/or are compliant with flame/smoke and toxicity regulations.

The fibrous structure may include one or more insert layers. The fibrous structure may include two or more insert layers. Where multiple insert layers are used, it is contemplated that the insert layers may be formed of the same materials. The insert layers may be different materials. One or more inserts could pass through the process to form the fibrous structure at the same time. For example, two insert layers may pass through the lapping machine simultaneously, with or without additional layers. The insert may be a pre-laminate of one or more layers. The insert may be a pre-laminate of two or more layers. These layers may include one or more films, one or more membranes, or a combination thereof.

A functional insert layer, or any other layer of the fibrous structure (e.g., a facing layer), may serve as a barrier for moisture, chemicals, dust, debris, or other particles or substances. The layer may be a generally nonporous material for acting as such a barrier. The layer may be a membrane insert for moisture blocking while retaining air flow. The membrane may be formed from or include any of the materials described herein. The membrane may be organic. The membrane may be inorganic. The membrane may, for example, include silicone and/or fluoropolymer base. The layer may allow for control of the rate of moisture transmission. The layer may be porous (e.g., with an increased number of pores or a greater cross-section of material to allow for such blocking). The layer may be generally polymeric, elastomeric, or both. The layer may be flexible. The layer may be treated to enhance wicking and/or hydrophobicity properties for moisture migration and/or handling. The layer may be a non-perforated polyolefin barrier layer. The layer may be a film. The layer may be a coating upon one or more of the webs. The layer may be moisture repellant or hydrophobic or may be coated with a moisture repellant or hydrophobic coating, such as a durable water repellent (DWR). The layer may be formed of or may include polysiloxanes, polytetrafluoroethylene, fluoropolymer type materials (e.g., polyvinylidene difluoride (PVDF)), silicone-based materials, silane-based materials, a repellant surfactant, lipid based coating or treatment, thermoset or thermoplastic materials (e.g., polypropylene (PP), polyethylene terephthalate (PET), polybutylene terephthalate (PBT), polytrimethylene terephthalate (PTT), polyurethane (PUR), polyphenylene sulfide (PPS), polyetherimide (PEI), polyether ether ketone (PEEK), polyimide (PI), poly(m-phenylene isophthalamide) (PMIA), polyamide-imide (PAI), or other polymeric material), the like, or a combination thereof.

A functional insert layer may include nanofibers. Nanofibers may have a mean fiber diameter of about 10 microns or less, about 5 microns or less, or about 1 micron or less. A nanofiber layer (or other layer of the material) may adsorptive properties. A nanofiber layer, or other layer of the material, may include adsorbing particulate matter. Nanoparticles of the nanofiber layer may include, for example, activated carbon, zeolites, oxides, and the like. The fibers forming the layer, or the layer itself, may be of a material that is more effective (e.g., as compared to a conventional layer or layer without the nanoparticles as envisioned herein) in trapping (e.g., permanently trapping) NO₂, rather than decomposing and/or being desorbed as NO₂ and NO.

A functional insert layer, or any other layer of the fibrous structure, may exhibit absorption properties. A functional insert layer may, for example, absorb moisture, fluids, particles, chemicals and the like. A functional insert layer may be superabsorbent. For example, a functional insert layer may include a superabsorbent polymer or a hydrogel. The functional insert layer may include superadsorbent materials, such as superadsorbent cellulose and/or wood pulp. The functional insert layer may include SAF fibers. A functional insert may be formed of spunbond (S) material, a spunbond and meltblown (SM) material, or a spunbond+meltblown+spunbond (SMS) nonwoven material. For example, a functional insert layer may include a spunbond fabric and a meltblown polypropylene layer.

A functional insert layer, or any other layer of the fibrous structure, may be selected to achieve desired acoustic absorption. A functional insert layer or other layer as described herein of the fibrous structure may provide additional air flow resistance (or air flow resistivity) to the fibrous structure. For example, a functional insert layer may have an air flow resistivity of about 100,000 Rayls/m or higher, about 275,000 Rayls/m or higher, 1,000,000 Rayls/m or higher, or even 2,000,000 Rayls/m or higher. The functional insert layer may create an acoustic impedance mismatch with other layers of the fibrous structure. The functional insert layer may, for example, be an air flow resistive insert such as a scrim insert.

The functional insert layer, or any other layer within the fibrous structure, may provide structural properties or may provide physical strength to the fibrous structure. Therefore, the functional insert layer may be formed of a material that is able to be lapped while still providing compression resistance, resilience, or both. The functional insert layer may be formed of a material that hardens or expands (e.g., upon activation) to provide stiffness or additional structural properties to the fibrous structure. The functional insert layer may be polymeric, where crystallinity can be adjusted to alter the structural properties of the fibrous structure. The crystallinity may be tuned, for example, during any heating and/or cooling process of the fibrous structure formation process. The functional insert layer may be formed of a polymeric, copolymeric, elastic, elastomeric, rubber, thermoplastic, thermosettable, or the like, material. The material may provide cushioning and/or resilience to the fibrous structure. The functional insert layer may include or may be formed from a powder. The powder may, for example, include ethylene vinyl acetate (EVA), ethylene propylene diene monomer (EPDM), or polyurethane (PUR). The functional insert layer may include or be formed from a thermoset curing powder, such as epoxy, which may be foamable, which may make the fibrous structure more rigid and/or resilient (e.g., as compared to a fibrous structure without such a layer).

The functional insert layer, or the fibrous structure as a whole, may provide insulative properties. The functional insert layer, or the fibrous structure as a whole, may be tuned to provide a desired thermal resistance. The functional insert layer, or the fibrous structure as a whole, may be tuned to provide a desired thermal conductivity. The functional insert layer, or the fibrous structure as a whole, may be tuned to provide desired properties, such as flame or fire retardance, smoke retardance, reduced toxicity, or the like. The functional insert layer may be able to withstand exposure to elevated temperatures.

A functional insert layer, or any other layer of the fibrous structure, may have high infrared reflectance or low emissivity. At least a portion of a functional insert layer may be metallized to provide infrared (IR) radiant heat reflection. The layer may be perforated. The layer may be permeable. The layer may be selectively permeable by design. The layer may be inherently permeable. To provide heat reflective properties to and/or protect other layers of the structure, the functional insert layer (e.g., fibers thereof, a surface of the insert layer, or the layer itself) may be metalized. For example, fibers may be aluminized. The fibers or layers themselves may be infrared reflective (e.g., so that an additional metallization or aluminization step may not be necessary). Metallization or aluminization processes can be performed by depositing metal atoms onto the fibers. As an example, aluminization may be established by applying a layer of aluminum atoms to the surface of fibers. Metalizing may be performed prior to the application of any additional layers to the fibrous web layer. It is contemplated that other layers of the fibrous structure may include metallized fibers in addition to, or instead of, having metallized fibers within the fibrous web layer.

A functional insert layer, or other layer of the fibrous structure, may be a conductive material. The functional insert layer may act to conduct heat and/or electricity. The functional insert layer or other layer of the structure may enable electromagnetic interference (EMI) attenuation. The layer may be formed form EMI shielding materials. The layer may be a metallic material or include a metallic material. For example, the layer may be or may include silver, gold, or copper or may be coated with such material. The functional insert layer, or other layer of the fibrous structure, may be charged. The functional insert layer, or other layer of the fibrous structure, may be electrostatically charged. The layer may be charged using electrically conductive material. For example, the material may be silicon carbide. Conductive particles, such as nanoparticles, may be used to form the layer. This may allow for using very little of an expensive substance, while still achieving benefits of charging, such as improved filtration. It is contemplated that one or more electrical leads may be attached to the layer or otherwise hooked to the layer to charge the layer. Such charging may cause the layer, or the fibrous structure in general, to hold more particulate matter (e.g., during filtration).

Where the functional insert layer may be exposed to high temperatures, the functional insert layer may include solid films, perforated films, solid foils, perforated foils, woven or nonwoven scrims, selectively permeable films or foils, or other materials. A functional insert layer may be formed from polybutylene terephthalate (PBT); polyethylene terephthalate (PET), polypropylene (PP), cellulosic materials, or a combination thereof. A functional insert layer may be formed from nonwoven material, woven material, or a combination thereof. A functional nonwoven layer may include polysilicic acid fibers, minerals, ceramic, fiberglass, or aramids. Films may include polyetheretherketone (PEEK), polyethersulfone (PES), polyetherketone (PEK), urethane, polyimide, or a combination thereof. The functional insert layer may be metallized to impart infrared reflectivity, thus providing an improved thermal insulating value to the overall fibrous structure. Any of the layers may have a thermal resistance capable of withstanding the temperatures to which the layers will be exposed. These materials, however, are not limited to use in high temperature applications, nor are they limited to only being used in a functional insert layer. It is contemplated that such materials may also be used for facing layers of the fibrous structure, for example.

A functional insert layer, or other layer of the fibrous structure, may be formed from or include an activatable or reactive material. The layer may be or may include an intumescent. A functional insert layer may be an expandable material. The expandable material may be any suitable polymeric material capable of expansion and adhesively bonding to a substrate upon curing. Illustrative materials are described in U.S. Pat. Nos. 5,884,960; 6,348,513; 6,368,438; 6,811,864; 7,125,461; 7,249,415; published U.S. Application No. 20040076831, incorporated by reference. The layer may provide for latent reaction or activation, such as a 2K insert or multicomponent insert. The layer may be formed from any type of reactive film or nonwoven to capture or scavenge chemicals or molecules from air or liquids. The layer may be a nanofiber type nonwoven that can be chemically altered to have such functionality.

A functional insert layer may be capable of providing other benefits, such as odor control and/or antimicrobial properties. For example, the layer may be an active carbon film insert or other nonwoven insert. The layer may include or be treated with copper, steel (e.g., stainless steel), silver, or other metallic materials. Other layers of the fibrous composite (e.g., carded layers) may include these components for achieving odor control and/or antimicrobial properties.

The fibrous structure may include one or more additional layers (e.g., in addition to one or more fibrous web layers and one or more functional insert layers). The additional layers may function to provide additional insulation properties, protection to the fibrous web layer or other layers, infrared reflective properties, conductive properties (or reduction of conductive properties), convective properties (or reduction of convective properties), structural properties, filtration properties, absorption properties (e.g., acoustic absorption, or absorption of liquids or chemicals), repellence of undesired external elements (e.g., liquids, sounds, particles, vibrations), or a combination thereof. The one or more layers may be formed of any of the materials as described herein with respect to the functional insert layers and/or fibrous layers. The fibrous structure may include one or more lofted layers, one or more skin layers, one or more facing layers, one or more foils, one or more films, or a combination thereof. The one or more layers may be formed from metals, fibrous material, polymers, or a combination thereof. A skin may be formed by melting a portion of the layer by applying heat in such a way that only a portion of the layer, such as the top surface, melts and then hardens to form a generally smooth surface. The fibrous structure may include a plurality of layers, some or all of which serve different functions or provide different properties to the fibrous structure (when compared to other layers of the fibrous structure). The ability to combine layers and skins of materials having different properties may allow the fibrous structure to be customized based on the application. One or more additional layers may be generally hydrophobic. One or more additional layers may be generally hydrophilic. One or more additional layers may be metallized or formed of a metallic material for IR reflectivity. A corrosion resistant coating may be applied to reduce or protect the metal (e.g., aluminum) from oxidizing and/or losing reflectivity. IR reflective coatings not based on metallization technology may be added. One or more coatings may be applied to the fibers forming the additional layer, or to the surface of the layer itself. Oleophobic and/or hydrophobic treatments may be added. Flame retardants may be added. One or more additional layers may be porous or perforated. One or more layers may be permeable or at least partially permeable. One or more additional layers may be solid (e.g., non-porous or non-perforated). One or more additional layers may be generally flexible. One or more additional layers may be generally rigid.

The fibrous structure may include one or more layers that have a high loft (or thickness), at least in part due to the orientation of the fibers of the layer (e.g., vertical or near-vertical orientation, or within about ±45 degrees from vertical). The fibrous structure may be of a relatively low weight yet still exhibit good resiliency and thickness retention. The fibrous structure, due to factors such as, but not limited to, unique fibers, facings, physical modifications to the three-dimensional structure (e.g., via processing), orientation of fibers, or a combination thereof, may exhibit good thermal insulation capabilities or thermal conductivity (e.g., lower) versus traditional insulation materials, acoustic absorption, air flow resistance, structural resilience, or the like.

As discussed, the fibrous structure may include a plurality of layers (e.g., higher density materials, porous limp sheets, fabrics, scrims, facings, films, meshes, adhesives, carded webs, air laid webs, the like, or a combination thereof). Two or more layers may be attached to each other through stacking and then vertically lapping the layers. Multiple layers may be incorporated into one line (e.g., a single pass through a lapping machine) to create the fibrous structure. The layers may be vertically lapped together to form a single vertically lapped structure. The vertically lapped structure may undergo one or more additional lapping steps (e.g., to vertically lap the vertically lapped structure). The layers may be attached to each other via adhesive. The adhesives may be a powder or may be applied in strips, sheets, or as a liquid, for example. Adhesive may be applied to one or more layers. Adhesive may be incorporated into one or more layers. One or more of the layers may be an adhesive layer. One or more components within one or more layers may act as an adhesive (e.g., bicomponent fibers). One or more layers of material forming the fibrous structure may be bonded together to create the finished fibrous structure. One or more layers may be bonded together by elements present in the layers. For example, the binder fibers in the layers may serve to bond the layers together. The outer layers (i.e., the sheath) of bi-component fibers in one or more layers may soften and/or melt upon the application of heat, which may cause the fibers of the individual layers to adhere to each other and/or to adhere to the fibers of other layers. Two or more layers may be attached to each other through the application of heat and/or compression. The layers may be attached to each other via one or more lamination processes. One or more layers may be secured to another layer through lamination, heat sealing, sonic or vibration welding, pressure welding, the like, or a combination thereof. Two or more layers may be attached to each other by a combination of these processes. Certain layers may be attached differently than other layers within the same fibrous structure. For example, one layer may be attached to an adjacent layer through an adhesive. Another layer may be attached to an adjacent layer via heating and melting of bicomponent fibers, fusing fibers of the layers together. One or more layers may be bonded to an adjacent layer. One or more layers may be able to move independently of another (e.g., adjacent) layer.

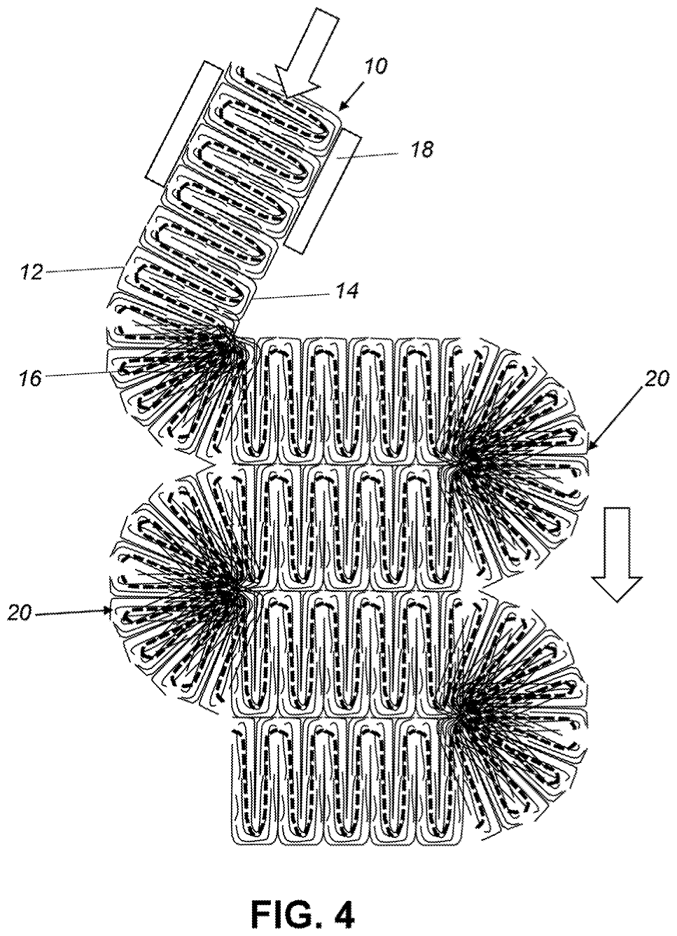

While two or more layers may be lapped together to form a lapped structure, other layers may be secured to the lapped structure separately. For example, a facing layer or scrim may be applied to the lapped structure. An additional functional layer may be applied to the lapped structure. Another lapped layer or structure may be secured to a lapped structure. Another intermediate layer formed from any of the materials or structures described herein may be positioned between two lapped structures. The lapped structure may be inserted into a lapping machine a second time, thereby creating a vertically lapped structure made of already vertically lapped layers (see FIG. 4). One or more layers of the fibrous structure (e.g., functional insert layer, facing layer, backing layer, intermediate layer, fibrous layer, the like, or a combination thereof) may be formed via an electrospinning or nanospinning process. The layer may be coated onto another layer of the fibrous structure. This may be performed, for example, before and/or after one or more lapping processes.

A vertically lapped three-dimensional structure may enable a facing or other layer to be tied to an external fibrous web layer (e.g., mechanically, thermally, or with an adhesive), such as when one or more fibrous web layers and one or more functional layers are lapped together and a fibrous web layer is an outer surface. Because the vertical loop is continuous through the thickness of the structure, a facing, fabric, or other layer may be tied on the top and the bottom of the structure. Fibers of a fibrous web layer and/or functional insert layer (e.g., surface fibers) may be mechanically entangled to tie the fibers together. This may be performed by a rotary tool, with the top of the head having a grit-type finish to grab and twist or entangle the fibers as it spins. The fibers (e.g., the surface of the fibrous web layer), then, can be entangled in the machine direction (e.g., across the tops of the peaks of the loops after lapping). It is contemplated that these rotating heads of the tool can move in both the x and y directions. The top surface of the fibrous web layer, the bottom surface of the fibrous web layer, or both surfaces may undergo the mechanical entanglement. The entanglement may occur simultaneously or at separate times. The process may be performed with a binder present. The process may be performed without binder (i.e., free of binder), with minimal binder, or with a binder of about 40% by weight or less of the web content. The mechanical entanglement may serve to hold the fibrous web layer together, for example, by tying the peaks of the three-dimensional loops together after the fibrous structure has undergone lapping. This process may be performed without compressing the fibrous web layer. The resulting surface of the fibrous web layer and/or functional insert layer may have improved tensile strength and stiffness of the vertical three-dimensional structure. The ability to tie the top surface to the bottom surface may be influenced by the fiber type and length, as well as the lapped structure having an integrated vertical three-dimensional loop structure from top to bottom. The mechanical entanglement process may also allow for mechanically tying fabrics or facings to the top and/or bottom surface of the lapped fibrous structure. The surface of the material may instead, or in addition to mechanical entanglement, be melted by an IR heating system, a hot air stream, or a laser beam, for example, to form a skin layer.

A fibrous structure or one or more layers thereof may be formed to have a thickness and density selected according to the required physical, insulative, and air permeability properties desired of the finished fibrous layer (and/or the fibrous structure as a whole). The layers of the fibrous structure may be any thickness depending on the application, location of installation, shape, fibers used (and the lofting of the fibrous web layer layer), or other factors. The density of the layers of the fibrous structure may depend, in part, on the specific gravity of any additives incorporated into the material comprising the layer (such as nonwoven material), and/or the proportion of the final material that the additives constitute. Bulk density generally is a function of the specific gravity of the fibers and the porosity of the material produced from the fibers, which can be considered to represent the packing density of the fibers. The fibrous material, which may be one or more of the fibrous structure layers, may be formed as a relatively thick, low density nonwoven, with a bulk density of about 5 kg/m or more, about 10 kg/m³ or more, about 15 kg/m³ or more, or about 20 kg/m³ or more. The thick, low density nonwoven may have a bulk density of about 200 kg/m or less, about 100 kg/m or less, or about 60 kg/m or less. The total thickness of the fibrous structure may depend upon the number and thickness of the individual layers and/or the distance between peaks and valleys (or loops) of the vertically lapped structure. It is contemplated that the total thickness may be about 0.5 mm or more, about 1 mm or more, or about 1.5 mm or more. The total thickness may be about 350 mm or less, about 250 mm or less, or about 175 mm or less. For example, the thickness may be in the range of about 2 mm to about 155 mm or about 4 mm to about 30 mm. It is also contemplated that some of the individual layers may be thicker than other layers. The thickness may vary between the same types of layers as well. For example, two lofted layers in the fibrous structure may have different thicknesses.

One or more layers may have a temperature resistance that is greater than or equal to the temperature resistance of the binder fibers. One or more layers may include a lower temperature fabric, scrim, or film between two fibrous web layers. The fibrous web layers may provide protection to the functional insert layer, thereby keeping it from burning and/or reaching its melting or softening temperature. One or more layers may have a melting or softening temperature that is greater than the temperatures to which the layers would be exposed while installed in an assembly. One or more layers may act as a moisture barrier to keep moisture in (e.g., within the inner walls of the fibrous structure) or to keep moisture out (e.g., away from the item to be insulated). One or more layers may be a hydrophobic layer which may have a certain porosity to allow for the composite structure to acclimate to air pressure changes without bursting. Such layer may be especially important in applications such as aerospace insulation. One or more layers may act as a chemical barrier or as a barrier to keep dirt, dust, debris, or other unwanted particles or substances away from the item to be insulated. For example, one or more fibrous structure layers may provide insulation. One or more fibrous structure layers may include one or more adhesive materials (e.g., as part of the fibers of the layer or as a separate element in or on the layer) for binding the fibers together, for binding layers together, or both. One or more fibrous structure layers may support a skin layer, other material layer, or both. One or more fibrous structure layers may provide heat resistance (e.g., if the fibrous structure is located in an area that is exposed to high temperatures). One or more fibrous structure layers may provide stiffness to the fibrous structure. Additional stiffness, structural properties, compression resistance, compression resiliency, or a combination thereof, may be provided by additional layers (or one or more layers in combination with the one or more fibrous matrix layers). One or more fibrous structure layers may provide flexibility and/or softness to the fibrous composite.

The fibrous web layer, the fibers forming the fibrous web layer, the resulting fibrous structure, or a combination thereof, may be used to form a thermoformable material. The fibrous structure may be thermoformable. This may allow the fibrous structure to be molded or otherwise shaped. The fibrous structure may have folding and/or bending functionality (e.g., to allow the structure to be secured or positioned within a desired area for achieving its desired purpose).

The vertical three-dimensional structure may allow for a higher degree of thermoforming detail, as the radius of curvature around a thick-to-thin transition area may be tighter, due the nature of vertical pleats being able to slide or shift beside one another in the thickness direction when under mold pressure and heat. One or more of the layers of the fibrous structure may contain a thermoplastic and/or thermoset binder. The binder may allow for the product to be thermobonded and formed into a stiffer structure. This may allow for facings, other layers, and/or adhesives to be laminated to the structure. It is contemplated that a fibrous web layer or the fibrous structure may be thermoformed without binder if certain fibers are used (e.g., due the nature of the cohesive attractiveness of inorganic fibers used). The thermoformable structure may be heated and thermoformed into a specifically shaped thermoformed product. The fibrous structure may have a varying thickness (and therefore a varied or non-planar profile) along the length of the material. Areas of lesser thickness may be adapted to provide controlled flexibility to the fibrous structure, such as to provide an area that is folded or otherwise shaped, such as to form a corner or angled portion (e.g., to serve as the vertex between two thicker portions of the material) to allow the fibrous structure to be shaped or inserted or installed into an area where the fibrous structure is to be employed. The fibrous structure may be sliced along its thickness (e.g., in a direction parallel to the outer surface of the fibrous structure) to produce two or more fibrous structures. For example, one fibrous structure may include all of the peaks of the vertically lapped structure and another fibrous structure may include all of the valleys of the vertically lapped structure.

Insulation properties, acoustic properties, or both, of the fibrous structure (and/or its layers) may be impacted by the shape of the fibrous structure. The fibrous structure, or one or more of its layers, may be generally flat. The fibrous structure may include a vertically lapped structure but may be generally planar overall. The finished fibrous structure may be fabricated into cut-to-print two-dimensional flat parts for installation into the end user, installer, or customer's assembly. The fibrous structure may be formed into any shape. For example, the fibrous structure may be molded (e.g., into a three-dimensional shape) to generally match the shape of the area to which it will be installed or the item to which it is meant to attach. The finished fibrous structure may be molded-to-print into a three-dimensional shape for installation into the end user, installer, or customer's assembly.

The fibrous structure may be secured within an assembly, such as an aircraft or automotive assembly. The fibrous structure may be secured to, within, or around an item within an assembly. One or more fibrous structure layers may attach directly to a wall, surface of a substrate, surface of an item of the assembly, or a combination thereof. The fibrous structure may be attached via a fastener, adhesive, or other material capable of securing the fibrous structure to a wall, substrate, or item of the assembly. The securing of the fibrous structure to itself or to another surface may be repositionable or permanent. The fibrous structure may include one or more fasteners, adhesives, or other known materials for joining a fibrous structure to a substrate, another portion of the fibrous structure, another fibrous structure, or a combination thereof. The fastener, adhesive, or other means of attachment may be able to withstand the elements to which it is exposed (e.g., temperature fluctuations). Fasteners may include, but are not limited to, screws, nails, pins, bolts, friction-fit fasteners, snaps, hook and eye fasteners, zippers, clamps, the like, or a combination thereof. Adhesives may include any type of adhesive, such as a tape material, a peel-and-stick adhesive, a pressure sensitive adhesive, a hot melt adhesive, the like, or a combination thereof. The fastener or adhesive, for example, that joins portions of the fibrous structure together may allow the fibrous structure to enclose or at least partially surround an item of the assembly and may hold the fibrous structure in that position. The fibrous structure may include one or more fasteners or adhesives to join portions of the fibrous structure to another substrate. For example, the fibrous structure may be secured to a portion of the assembly, such as an aircraft or vehicle assembly, to hold the fibrous structure in place within the assembly.

The one or more fasteners may be separately attached to or integrally formed with one or more layers of the fibrous structure. For example, the fibrous structure may include one or more tabs, projections, or a male-type fastener portion (e.g., at one end of the fibrous structure), and a corresponding opening or female-type fastener portion (e.g., on the opposing end of the fibrous structure) that can be received within the male-type fastener portion to hold the fibrous structure in a desired position. When the fibrous structure is to be formed into the desired shape, the end of the fibrous structure can be attached to the opposing end, thereby forming an enclosure.

The fibrous structure, or parts thereof, may retard fire and/or smoke. The fibrous structure, or parts thereof, particularly the functional insert layer, may be capable of withstanding high temperatures without degradation (e.g., temperatures up to about 1150° C.).

The fibrous structure as described herein may also provide sound absorption characteristics. With fibrous materials, air flow resistance and air flow resistivity are important factors controlling sound absorption. Air flow resistance is measured for a particular material at a particular thickness. The air flow resistance is normalized by dividing the air flow resistance (in Rayls) by the thickness (in meters) to derive the air flow resistivity measured in Rayls/m. ASTM standard C522-87 and ISO standard 9053 refer to the methods for determination of air flow resistance for sound absorption materials. Within the context of the teachings herein, air flow resistance, measured in mks Rayls, will be used to specify the air flow resistance; however other methods and units of measurement are equally valid. Within the context of the described teachings, air flow resistance and air flow resistivity can be assumed to also represent the specific air flow resistance, and specific air flow resistivity, respectively. Acoustic materials for sound absorption may have a relatively high air flow resistance to present acoustic impedance to the sound pressure wave incident upon the material. Air permeability should be managed to ensure predictable and consistent performance. This may be achieved through management of fiber sizes, types, and lengths, among other factors. A homogeneous, short fiber nonwoven textile may be desirable. In some applications, desirable levels of air permeability may be achieved by combining plural materials (which may include nonwovens) of differing densities together to form a composite product.

Insulation, filtration, sound absorption, structural properties, resilience, fire retardance, smoke retardance, toxicity, the like, or a combination thereof, can be tuned by adding one or more layers to the fibrous structure. These layers may have different levels of thermal conductivity. These layers may have different levels of specific air flow resistance. In a multi-layer fibrous structure, some layers may have a lower air flow resistance while other layers may have a higher air flow resistance. The layering of layers having different air flow resistive properties may produce a multi-impedance acoustic mismatched profile through the entire fibrous structure, which provides improved noise reduction capability of the fibrous structure. Therefore, the layers (or skins) may be arranged so that a layer (or skin) of higher specific air flow resistance is joined to, or formed on, or is adjacent to one or more layers of a different specific air flow resistance (e.g., a lower air flow resistance).

The fibrous material (e.g., serving as one or more fibrous structure layers) thus formed may have an air flow resistivity of about 100 Rayls/m or more, about 400 Rayls/m or more, about 800 Rayls/m or more, or about 1000 Rayls/m or more. The fibrous composite material may have an air flow resistivity of about 200,000 Rayls/m or less, about 150,000 Rayls/m or less, or about 100,000 Rayls/m or less. Low density fibrous composite materials may even have an air flow resistivity of up to about 275,000 Rayls/m.

Additional sound absorption may also be provided by a skin layer on a fibrous layer (e.g., by an in-situ skinning process), facing layer, one or more functional layers, or a combination thereof. A skin layer or other layer as described herein of the fibrous structure may provide additional air flow resistance (or air flow resistivity) to the fibrous structure. For example, the skin layer may have an air flow resistivity of about 100,000 Rayls/m or higher, about 275,000 Rayls/m or higher, 1,000,000 Rayls/m or higher, or even 2,000,000 Rayls/m or higher.

The present teachings also contemplate methods of forming a fibrous structure. The fibrous structure may include one or more fibrous web layers. The method may include forming one or more fibrous web layers. The fibers forming the fibrous web layer may be formed into a nonwoven web using nonwoven processes including, for example, opening fibers, blending fibers, carding, lapping, air laying, mechanical formation, or a combination thereof. The fibers may be opened and blended using conventional processes.

The fibrous web may be formed, at least in part, through a carding process. The carding process may separate tufts of material into individual fibers. During the carding process, the fibers may be aligned in substantially parallel orientation with each other and a carding machine may be used to produce the web. Therefore, the resulting structure may be a carded web layer. The carded web layer, or any other layer of the fibrous structure, may be engineered for optimum weight, thickness, physical attributes, thermal conductivity, filtration properties, pore size, insulation properties, acoustic absorption, the like, or a combination thereof.

One or more layers of the fibrous structure may be formed by an air laying process. This air laying process may be employed instead of carding and/or lapping. In an air laying process, fibers are dispersed into a fast moving air stream, and the fibers are then deposited from a suspended state onto a perforated screen to form a web. The deposition of the fibers may be performed by means of pressure or vacuum, for example. An air laid or mechanically formed web may be produced. The web may then be thermally bonded, air bonded, mechanically consolidated, the like, or combination thereof, to form a cohesive nonwoven insulation material. While air laying processes may provide a generally random orientation of fibers, there may be some fibers having an orientation that is generally in the vertical direction so that resiliency in the thickness direction of the material may be achieved.

The method of forming the fibrous structure also includes using a functional insert layer. The functional insert layer may be provided as a continuous layer. The functional insert layer may be supplied as a roll. The layer may then be unrolled during the assembly of the fibrous structure (e.g., to supply the material to a lapping machine). The functional insert layer may be applied to another layer of the fibrous structure (e.g., as a coating). The functional insert layer may be positioned upon and/or below another layer of the fibrous structure. The functional insert layer may be sandwiched between two layers of the fibrous structure. One or more functional insert layers and one or more fibrous web layers may be introduced into a lapping machine. The one or more functional insert layers and one or more fibrous web layers may be stacked on top of each other and/or inserted in a generally parallel position to each other into a lapping machine.

Layers of the fibrous structure (e.g., one or more functional insert layers and one or more fibrous web layers) may undergo a lapping process. This lapping process may produce a lofted fibrous structure. One or more layers of the fibrous structure may be rotary lapped, cross-lapped, or vertically lapped, to form a voluminous or lofted nonwoven material. One or more layers of the fibrous structure may be vertically lapped according to processes such as “Struto” or “V-Lap”, for example. This construction provides a fibrous structure having one or more, or two or more, layers having a lapped structure. For example, a functional insert layer may be sandwiched between two fibrous web layers. All three layers may be introduced to the lapping machine simultaneously to produce a single vertically lapped fibrous structure. Multiple lines may feed a lapping machine to form the fibrous structure. For example, one or more carding lines may feed the lapper to form the finished structure. The carding lines may provide different carded web layers. The carding lines may provide the same carded web layers (e.g., having the same makeup). One or more additional lines may supply one or more functional insert layers. It is contemplated that two or more, three or more, five or more, or even seven or more layers may be fed into the lapping machine to produce the fibrous structure. The fibrous structure may have a relatively high structural integrity in the direction of the thickness of the fibrous structure (e.g., as compared to a vertically lapped structure having only one layer). This may provide desired properties to the fibrous structure, as well as resiliency, compression resistance, structural properties, and/or minimizing the probability of the web or fibrous structure falling apart during application, or in use. Carding and lapping processes, especially those involving the simultaneous lapping of two or more layers (e.g., one or more carded layers and one or more functional insert layers), may create a fibrous structure that has good compression resistance through the vertical cross-section (e.g., through the thickness of the material) and may enable the production of a lower mass fibrous structure, especially with lofting to a higher thickness without adding significant amounts of fiber to the matrix. A small amount of hollow conjugate fiber (i.e., in a small percentage) may improve lofting capability and resiliency to improve filtration, insulation, sound absorption, the like, or a combination. Such an arrangement may also provide the ability to achieve a low density web with a relatively low bulk density.

When viewing from the side or at a cross section, the lapped structure may have fibers and/or layers oriented in a generally sinusoidal arrangement or pleated arrangement with peaks and valleys, or loops, at generally opposing faces or surfaces of the fibrous structure. The peaks and/or valleys may be generally aligned with each other. The peaks and/or valleys may be positioned in such a way that there is no separation between the peaks and/or valleys, respectively. Whereas a conventional filter has separated pleats, it is contemplated that the present structure may have little to no space between one peak or valley and an adjacent peak or valley. For example, there may be a distance between one crest or trough and an adjacent crest or trough of about 100 mm or less, about 50 mm or less, about 25 mm or less, about 10 mm or less, or about 5 mm or less. The absence of a large gap between peaks and/or valleys may reduce the pressure drop of the material by offering higher media volume per projected area. In addition, the configuration of peaks, valleys, loops or the like may allow for an increase in thickness of the lapped structure (e.g., as compared to a traditional filter material, about 30 mm or greater, or both). This increase in thickness or increase in height of loops may serve as an effective way to increase media surface area. The increased surface area may reduce pressure drop, improve filtration efficiency, increase dust-holding capacity, or a combination thereof. For example, an increase of about 5 mm from a traditional filter may add about 17% surface area to a filter.

The lapped structure, other layer in the fibrous structure, or the fibrous structure in general, may have one or more voids, gaps, openings, or spaces (referred to hereafter as spaces for simplicity). The spaces may be between layers, within a layer, or a combination thereof. For example, there may be space between one layer and another layer (e.g., between the insert layer and a lapped layer). The space may act as a pocket or depository. Such pocket or depository may function for holding particles, dust, or other elements, such as during filtration.

The fibers and/or layers extending in the thickness direction may have a generally vertical, where vertical is defined as extending along the thickness of the material between the top surface and the bottom surface of the material or extending generally along a transverse plane extending through the cross-section of the material, or near-vertical orientation, where near-vertical is measured as within about ±20 degrees from vertical, about ±10 degrees from vertical, or about ±5 degrees from vertical. The orientation of fibers and/or layers may be altered after processing steps, such as carding, lapping, and/or air laying. The alteration of orientation may be performed to meet the needs of the application. The fibers or layers leading to each peak and/or valley forming the lapped fibrous structure may have an orientation within about ±60 degrees from vertical, about ±50 degrees from vertical, or about ±45 degrees from vertical. Therefore, a vertical fiber orientation means that the fibers are generally perpendicular to the length of the fibrous structure (e.g., fibers extending in the thickness direction). A vertical layer orientation means that the layers are generally perpendicular to the length of the fibrous structure between a peak and valley of the lapped structure. The fibers forming the lapped fibrous structure may be generally horizontally oriented (e.g., fibers extending in the length and/or width direction).

The fibrous structure, or layers thereof, may be compressed in the length direction. The compression may provide stiffness to the fibrous structure, increase filtration ability of the material, or both. The compression may shorten the fibrous structure or layers thereof in the length directions. The compression may cause the pleats or loops to be closer together. Compression may occur, for example, after a step of vertically lapping the lapped structure. During compression, a structure may prevent or control the thickness of the material. In a compression step, a structure may be provided that includes a pair of generally parallel plates, where the fibrous structure or layers thereof (e.g., the lapped layer) is received therebetween. A perpendicular wall or plate may be located between and/or join the parallel plates. The perpendicular wall may serve as a stop for the vertically lapped material or a contact plate to assist in the compression of the fibrous structure or layers thereof in the lengthwise direction. A force applying member, such as a slider, may be generally parallel to the perpendicular wall, may move toward the perpendicular wall, may be located on an opposing side of the fibrous structure or layers thereof from the perpendicular wall, or a combination thereof. When the fibrous structure, or layers thereof, such as a lapped structure, is positioned between the parallel plates, perpendicular wall, and the force applying member, the force applying member may push the material into the perpendicular wall, and the parallel plates may limit the height or thickness of the material during the compression step.

The fibrous structure may be compressed, gauged, thermoformed, laminated, or the like, to a reduced thickness. The fibrous structure may be compressed in the thickness direction, in the length direction, or both, by 10% or more, about 20% or more, or about 30% or more. The fibrous structure may be compressed, in the thickness direction, in the length direction, or both, by about 70% or less, about 65% or less, or about 60% or less. When the thickness is reduced, this may cause the fibers to become non-vertical. Compression of the lapped structure may cause the fiber orientation or layer orientation of the cross section to take a generally Z-shape, generally C-shape, or generally S-shape, for example. While shapes are referred to herein as Z-type, C-type, or S-type, the non-vertical orientation of fibers is not limited to these shapes. The shapes could be a combination of these types, may be free-form shapes having an irregular contour, or may be other types of non-vertical orientations.

A non-vertical fiber orientation or layer orientation (e.g., due to compression, gauging, laminating, or thermoforming) may reduce the direct short-circuit type of conductive heat transfer from one surface of the fibrous web layer to the other through the fiber filaments. Such non-vertical fiber or layer orientation may also provide for blocking of a direct convective heat transfer path for heat flow through the fibrous web layer. As such, a non-vertical (e.g., Z-type, C-type, or S-type) shape may create a baffle effect to conductive and/or convective heat transport. Such non-vertical orientation of fibers and/or layers may also act to enhance absorption (e.g., acoustic absorption or absorption of chemicals, oils, water, or other liquids). Such orientation may also impact filtration properties. Such orientation may also impact vibration damping.

The fibrous structure may include a pressure sensitive adhesive (PSA). The PSA may be located on any part of the fibrous structure. For example, the PSA may be located on an inner surface of the fibrous structure. The PSA may be located on an outer surface of the fibrous structure, which may allow the fibrous structure to be secured to a wall or surface within the assembly, such as a vehicle assembly. The PSA may be located on a portion of the fibrous structure that contacts another portion of the fibrous structure (or another fibrous structure) so that the fibrous structure holds its desired shape and/or position. The PSA may be located between one or more layers of the fibrous structure (e.g., to join one or more layers). The PSA may be applied from a roll and laminated to at least a portion of the fibrous structure. A release liner may carry the PSA. Prior to installation of the fibrous structure, the release liner may be removed from the PSA to allow the fibrous structure to be adhered to a substrate, the item to be insulated, or to another portion of the fibrous structure, for example. It is contemplated that the release liner may have a high tear strength that is easy to remove to provide peel-and-stick functionality and to ease installation. The PSA may coat a portion of the fibrous structure. The PSA may coat an entire side or surface of the fibrous structure. The PSA may be coated in an intermittent pattern. The intermittent coating may be applied in strips or in any pattern, which may be achieved by hot-melt coating with a slot die, for example, although it can also be achieved by coating with a patterned roller or a series of solenoid activated narrow slot coating heads, for example, and may also include water and solvent based coatings, in addition to hot-melt coating. Where the PSA coating is applied intermittently, the spacing of the strips or other shape may vary depending on the properties of the fibrous structure. For example, a lighter fibrous material may need less PSA to hold the material in place. A wider spacing or gap between the strips can facilitate easier removal of the substrate, as a person can more readily find uncoated sections that allow an edge of the substrate to be lifted easily when it is to be peeled away to adhere the fibrous structure material to another surface. The pressure sensitive adhesive substance may be an acrylic resin that is curable under ultraviolet light, such as AcResin type DS3583 available from BASF of Germany. A PSA substance may be applied to substrate in a thickness of about 10 to about 150 microns, for example. The thickness may alternatively be from about 20 to about 100 microns, and possibly from about 30 to about 75 microns, for example. Other types of PSA substance and application patterns and thicknesses may be used, as well as PSA substances that can be cured under different conditions, whether as a result of irradiation or another curing method. For example, the PSA substance may comprise a hot-melt synthetic rubber-based adhesive or a UV-curing synthetic rubber-based adhesive. The PSA substance may be cured without UV curing. For example, the PSA could be a solvent or emulsion acrylic which may not require UV curing. While PSA adhesives are discussed herein, other adhesives are also contemplated. For example, the material could be secured using a wet (water-based) emulsion adhesive.

The fibrous structure may include one or more framing elements. The framing elements may surround one or more edges of the fibrous structure. The framing elements may be separate or discrete elements. The framing elements may be integrated into the fibrous structure. The framing elements may be heat formed or heat sealed. This heat forming or heat sealing may allow for integration of walls or other features into the fibrous structure, thereby acting to eliminate or reduce the need for separate frame manufacture and/or assembly. The heat forming or heat sealing may allow for sealing the fibrous structure around the edges to have a fully sealed system. Heat and/or compression may be applied to one or more edges of the fibrous structure. This may cause only a certain part of the fibrous structure (e.g., along the edge) to form a lip or thinned portion. This lip or thinned portion may be folded or otherwise positioned to seal or frame the fibrous structure. The folding may cause the lip or thinned portion to be positioned about 45 degrees or more, about 75 degrees or more, or about 90 degrees or more from its initial position prior to folding. The folding may cause the lip or thinned portion to be positioned about 180 degrees or less from its initial position prior to folding. A living hinge or cutout may be incorporated into the system to allow for increased bendability. The living hinge or cutout may be provided, for example, during the heat and/or compression step, where the heating and/or compression member includes a projection or extended portion that causes further compression in one area to create the hinge.

The finished fibrous structure may be useful in filtration.

The finished fibrous structure may be useful in particle filtration, such as fine particle filtration. The fibrous structure may create a fiber density profile to mechanically filter different particle sizes. The filtration may be performed with the use of electrostatic charging. The filtration may be performed without the use of electrostatic charging. Without relying on electrostatically charged fibers, this may eliminate or reduce loss of filtration efficiency as a function of aging area. This may provide for constantly increasing filtration performance with minimal or no obvious aging degradation. This may allow for or enable on-board air quality monitoring systems. One or more layers, such as a nanofiber layer, may be employed to enable higher fine particle filtration efficiency. The fibrous structure may create a density gradient from one surface toward the opposing surface. Large particles, for example, may be trapped near the first surface to maintain a low pressure drop. Smaller particles may travel deeper until trapped in the higher density zones. Different fibers or materials may be located toward or at the opposing surface to provide additional functions, such as adsorption.

The fibrous structure may provide for selective and/or functional filtration. One or more layers or fibers within the fibrous structure may be chemically modified to selectively filter chemicals from a gas. One or more layers or fibers within the fibrous structure may be pre-treated with a chemical additive. One or more layers or fibers within the fibrous structure may have chemical modification to where there are molecules within the structure that scrub certain chemicals.

One or more layers (e.g., an insert layer) or the fibrous structure as a whole may provide for gas and/or odor adsorption. One or more layers (e.g., an insert layer) or the fibrous structure as a whole may scavenge odors or chemicals. This may occur without being used within a blowing air stream like a filter. For example, the fibrous structure may be a panel installed in an area (e.g., in static mode) or inside a box that encloses something. One or more layers (e.g., an opposing layer from the source of the gas) may be used for gas adsorption. This may increase the available volume of carbon or other surface chemistries to deal with volatile organic compounds (VOCs). Use of carbon fibers or carbon-coated fibers may increase adsorption capacity. The use of these fibers may avoid the need to seal the fibrous structure against the risk of carbon dust release. These fibers may be present in one or more layers of the fibrous structure (e.g., one or more fibrous layers, one or more insert layers, or a combination thereof). The fibers may be added during an initial layer-forming process, added in a second or separate carding process, in an air laying process, or a combination thereof. These fibers may be located toward one side of the fibrous structure (e.g., toward a back side or an opposing side from the source of the fluid) so it can be partially protected by other layers in the overall construction. The fibrous structure may incorporate one or more antimicrobial materials (e.g., silver-based coatings or fibers), carbon coatings, or other adsorptive chemistries to remove interior odor and/or prevent bacterial growth inside the fibrous structure.

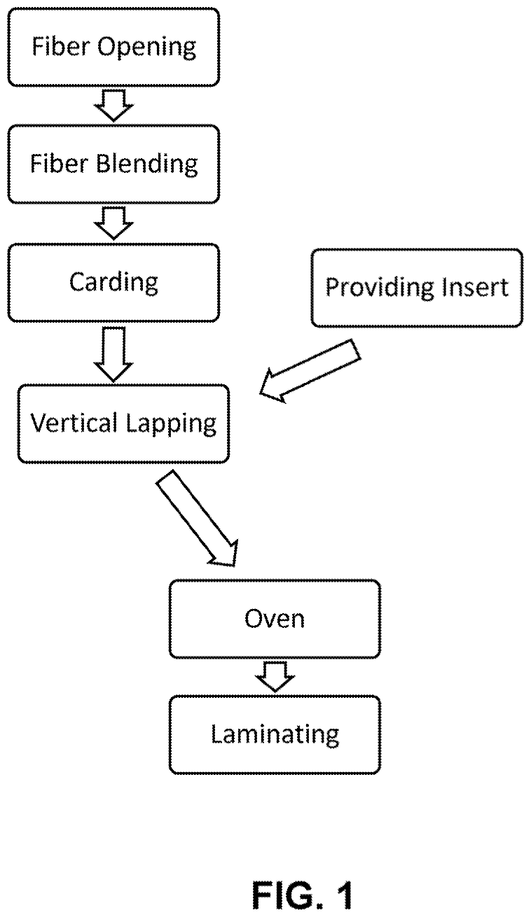

Turning now to the figures, FIG. 1 illustrates an exemplary process of forming the fibrous structure of the present teachings. The fibrous structure of the present teachings includes two or more layers. One or more layers are formed from a process of a fiber opening step, a fiber blending step, and a carding step. The carding step produces a fibrous web. A functional insert layer may be introduced with one or more fibrous webs to a machine capable of vertically lapping materials. The one or more fibrous webs and the functional insert layer may be introduced to the lapper in an orientation generally parallel to each other (e.g., with one or more of the layers stacked on top of another layer) so that the lapping process causes the layers to be lapped together. The lapped material may then be introduced to an oven and/or laminator. The application of heat may cause one or more layers to join or bond to each other (e.g., by melting fibers, parts thereof, or other adhesive material to bond to other fibers or layers), activate one or more layers or components therein (e.g., to cause expansion and/or adhesion), and the like. Other layers may be added to the lapped material, such as facing and/or layers, which may occur during the lamination process. Compression of the fibrous structure may also be performed during the process, such as during the lamination step.

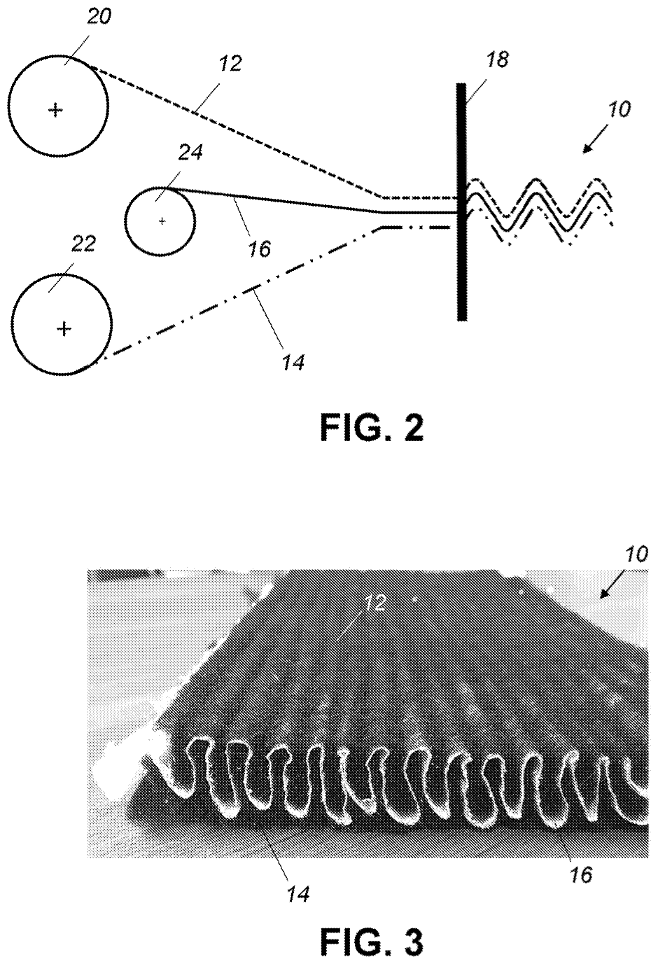

FIG. 2 illustrates part of the process of forming a fibrous structure 10. A first carded web 12, a second carded web 14, and a functional insert layer 16 therebetween are introduced into a lapping machine 18 (e.g., via a top card doffer roll 20, bottom card doffer roll 22, and an insert roll let off 24), which produces the vertically lapped fibrous structure 10. An exemplary fibrous structure 10 is shown in FIG. 3, where a functional insert layer 16 is sandwiched between a first carded web 12 and a second carded web 14. As shown, the three layers have a vertically lapped structure, with the functional insert layer providing or enhancing desired properties of the fibrous structure.

FIG. 4 illustrates a vertically lapped fibrous structure 10 that has undergone an additional lapping process. The fibrous structure 10, having a first carded web 12, a second carded web 14, and a functional insert layer 16 therebetween, is vertically lapped to create the fibrous structure. The fibrous structure 10 is then again introduced into a lapping machine 18, which creates loops 20 or peaks and valleys. Such a structure may provide additional properties, such as compression resistance, insulation, filtration, and the like.

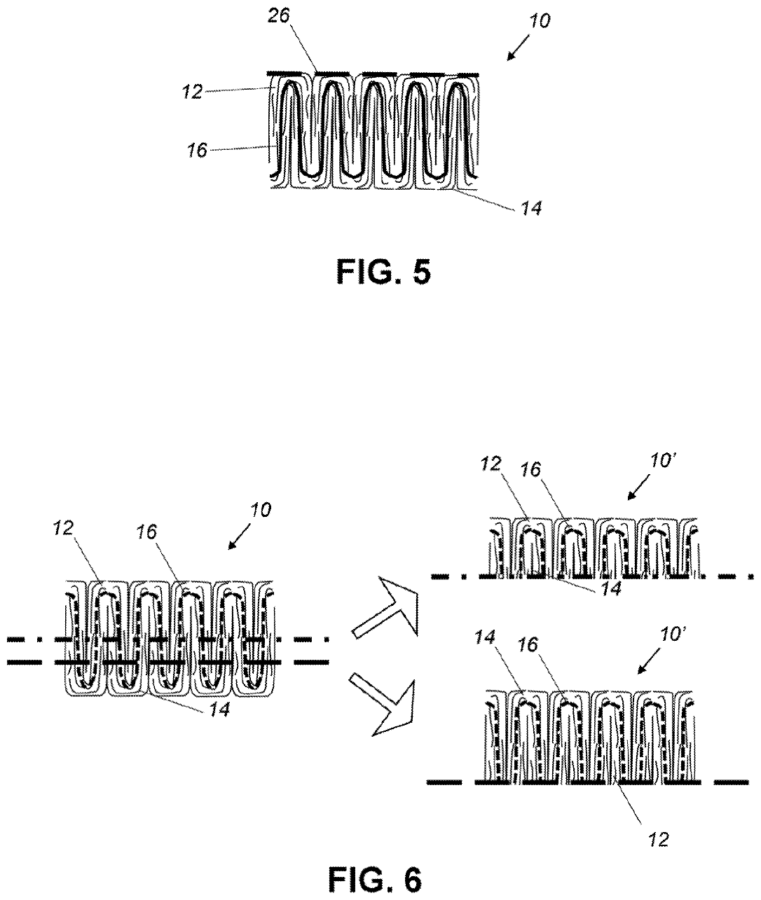

FIG. 5 illustrates a fibrous structure 10 where a first carded web 12, a second carded web 14, and a functional insert layer 16 are vertically lapped. Following the lapping process, a facing layer 26 is secured to the first carded web 12, though it is contemplated that a facing or backing layer can be applied to any layer of the structure. The facing layer 26 as shown herein is perforated or otherwise permeable, which may, for example, act as a series of Helmholtz resonators.

FIG. 6 illustrates a fibrous structure 10 that has been sliced into two partial fibrous structures 10′ along the dotted lines through the thickness of the fibrous structure. The fibrous structure 10 includes a first carded web 12, a second carded web 14, and a functional insert layer 16 therebetween. The partial fibrous structures 10′ still include at least a portion of these layers. As shown, one partial fibrous structure 10′ includes all of the peaks of the vertically lapped structure and the other partial fibrous structure 10′ includes all of the valleys of the vertically lapped structure. Such slicing of the fibrous structure may be useful, for example, for saving costs, materials, reducing thickness of the material, providing a different surface for adhering or otherwise securing another layer to the partial structure, the like, or a combination thereof.

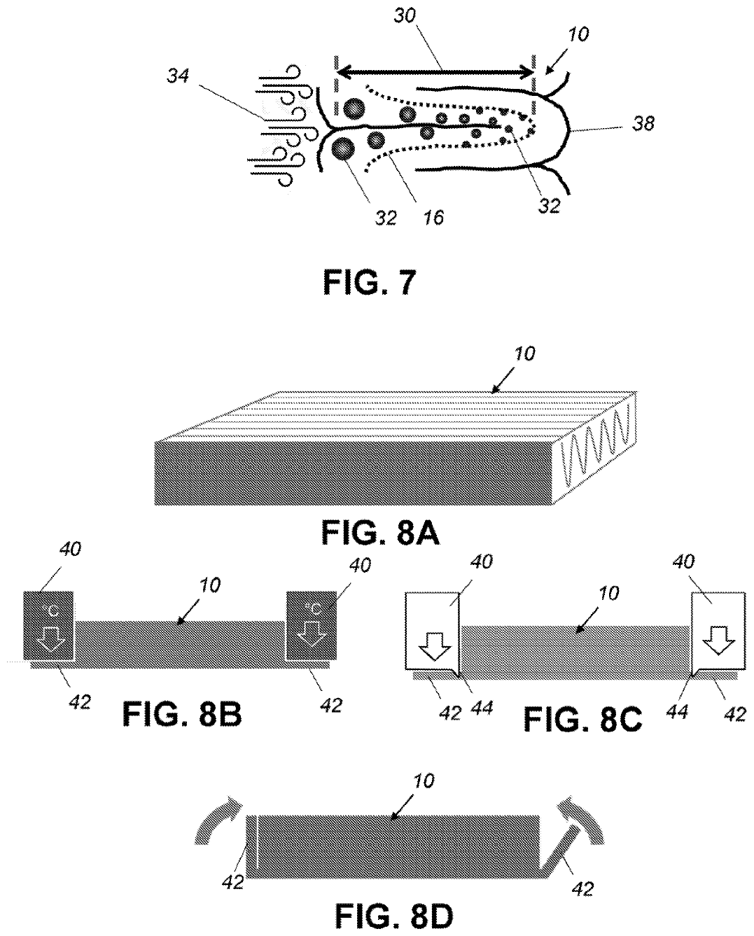

FIG. 7 illustrates a portion of a fibrous structure 10 capable of performing a filtration function. The fibrous structure 10 includes a fiber density gradient 30 that allows particles 32 of differing sizes to be filtered through the material. In performing the filtration, incoming airflow 34 is directed toward an exterior surface 36 (which may, for example, be a first carded web 12 or second carded web 14 as shown in FIGS. 2 and 3) of the fibrous structure 10. The larger particles 32 are trapped toward the exterior surface 36, while the finer particles 32 are trapped closer to the functional insert material 16, which may be a nanofilm or layer made up of nanoparticles. The trapping of larger particles near the exterior surface allows for maintaining a low pressure drop, while the smaller particles travel deeper until trapped in higher density zones. The opposing surface 38 (which may, for example, be a first carded web 12 or second carded web 14 as shown in FIGS. 2 and 3) may include carbon coated fibers or other carbon materials or surface chemistries to enhance adsorption capacity.

FIGS. 8A, 8B, 8C, and 8D illustrate integration of walls or other features into the fibrous structure 10, eliminating frame manufacture and assembly. FIG. 8A shows a fibrous structure 10 cut to shape. FIGS. 8B and 8C illustrate possible heating and/or compression members 40 that form a compressed edge 42 of the fibrous structure 10. The compressed edge may include a living hinge or sealing lip, which may be formed through an extended portion 44 on the heating and/or compression member 40, as shown in FIG. 8C. FIG. 8D shows the compressed edges 42 being folded upward along the path of the arrows to form side walls. The side walls may act to prevent leakage out of the fibrous structure 10.

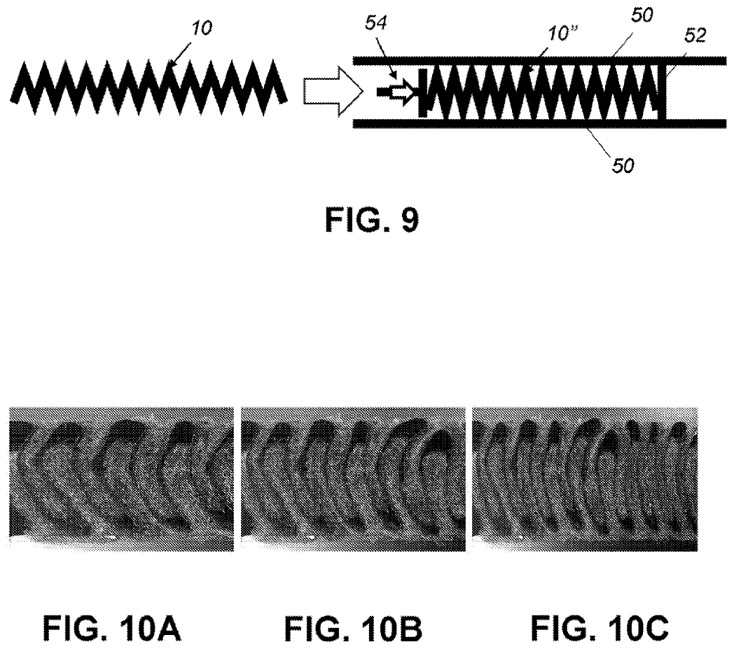

FIG. 9 illustrates a process of compressing a fibrous structure 10 in the length direction to form a compressed fibrous structure 10″. The fibrous structure 10 is inserted between plates 50 to control the thickness of the material during compression. A wall 52 perpendicular to and extending between the plates 50 acts as a further boundary and support during the compression step. Compression is performed by a slider 54 that travels toward the wall 52 to compress the material therebetween, forming the compressed fibrous structure 10″.

FIGS. 10A, 10B, and 10C are images of fibrous structures. The camera is in the same position for each image, so the only change between the images is the number of pleats as a result of the compression (i.e., the length of the material shown is the same for all three images). FIG. 10A is an image of a fibrous structure 10 as shown in FIG. 9. FIG. 10B is an image of a partially compressed fibrous structure, which may be compressed according to the method shown in FIG. 9. FIG. 10C is a highly compressed fibrous structure, which may be compressed according to the method shown in FIG. 9. Through the compression in the length direction, additional pleats are provided over the same distance.

Any of the fibers or materials as discussed herein, especially with respect to the fibrous web layer and/or processes of forming the fibrous web layer, may also be employed to form or may be included within any of the additional layers of the fibrous structure, such as facing layers, functional insert layers, scrims, and the like. Any of the materials described herein may be combined with other materials described herein (e.g., in the same layer or in different layers of the fibrous structure). The layers may be formed from different materials. Some layers, or all of the layers, may be formed from the same materials, or may include common materials or fibers. The type of materials forming the layers, order of the layers, number of layers, positioning of layers, thickness of layers, or a combination thereof, may be chosen based on the desired properties of each material (e.g., infrared reflectivity, insulation properties, conductive properties, convective properties, compression and/or puncture resistance, filtration properties, absorption properties, repellence properties, and the like), the insulation properties of the fibrous structure as a whole, the heat transfer properties of the fibrous structure as a whole, the desired air flow resistive properties of the fibrous structure as a whole, the desired weight, density and/or thickness of the fibrous structure (e.g., based upon the space available where the fibrous composite will be installed), the desired flexibility of the structure (or locations of controlled flexibility), or a combination thereof. The layers may be selected to provide varying orientations of fibers. One or more fibrous structure layers may be any material known to exhibit sound absorption characteristics, insulation characteristics, flame retardance, smoke retardance, or a combination thereof. One or more fibrous structure layers may be at least partially formed as a web of material (e.g., a fibrous web). One or more fibrous layers may be formed from nonwoven material, such as short fiber nonwoven materials. One or more fibrous layers may be formed from a woven material. One or more fibrous layers may be formed by thermally melting the surface of a fibrous web layer to form a skin layer. One or more layers may be a fabric, a film, a foil, or a combination thereof. One or more layers may be an air flow resistive layer. One or more layers may be a hydrophobic layer. One or more layers may be a hydrophilic layer. One or more layers may be a spunbond (S) material, a spunbond and meltblown (SM) material, or a spunbond+meltblown+spunbond (SMS) nonwoven material. Such a composite material may provide a combination of performance, including a built-in pressure release mechanism to allow the material to acclimate as pressure changes. This may be particularly useful in insulation blankets for aircrafts, as pressure in the cabin changes. One or more fibrous structure layers may be a porous bulk absorber (e.g., a lofted porous bulk absorber formed by a carding and/or lapping process). One or more fibrous structure layers may be formed by air laying. The fibrous structure may be formed into a generally flat sheet. The fibrous structure (e.g., as a sheet) may be capable of being rolled into a roll. The fibrous structure (or one or more of the fibrous structure layers) may be an engineered 3D structure. It is clear from these potential layers that there is great flexibility in creating a material that meets the specific needs of an end user, customer, installer, and the like.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32, etc. are expressly enumerated in this specification. For values which are less than one, one unit is considered to be 0.0001, 0.001, 0.01, or 0.1 as appropriate. These are only examples of what is specifically intended and all possible combinations of numerical values between the lowest value, and the highest value enumerated are to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. An article comprising:
a fibrous structure including one or more nonwoven layers comprising a fibrous web layer and one or more functional insert layers for providing additional properties to the material;
wherein one or more of the nonwoven layers and one or more functional insert layers are lapped together to form a vertically lapped structure; and
wherein the functional insert layer is a continuous sheet of material prior to lapping.

2. (canceled)

3. (canceled)

4. The article of claim 1, wherein the functional insert layer is sandwiched between two nonwoven layers, and wherein the functional insert layer and two nonwoven layers are lapped together to form a single vertically lapped structure.

5. The article of claim 1, wherein the functional insert layer is a filtration media insert for filtering fluids.

6. The article of claim 1, wherein the functional insert layer is a material for providing cushioning or resilience to the fibrous structure.

7. The article of claim 1, wherein the functional insert layer is an expandable material.

8. The article of claim 1, wherein the functional insert layer is a low melt or thermoset material to allow the layer to be molded.

9. The article of claim 1, wherein the functional insert layer is a conductive material.

10. The article of claim 1, wherein the functional insert layer is a superabsorbent material.

11. The article of claim 1, wherein the functional insert layer is a film or foil.

12. The article of any of claim 11, wherein the film or foil is perforated or selectively permeable.

13. The article of claim 1, wherein the functional insert layer is a membrane layer for blocking moisture and/or controlling a rate of moisture transmission.

14. The article of claim 1, wherein the functional insert layer, one or more nonwoven layers, or a combination thereof includes adsorptive materials.

15. (canceled)

16. The article of claim 1, wherein the fibrous structure is thermoformable to shape the fibrous structure into a three-dimensional shape.

17. The article of claim 1, wherein the fibrous structure includes one or more films, facings, scrims, skins, fabrics, adhesives, or a combination thereof laminated to one or more sides of the vertically lapped structure.

18. (canceled)

19. (canceled)

20. The article of claim 1, wherein the article, the functional insert layer, or both, is a fire retardant material.

21. (canceled)

22. The article of claim 1, wherein the article includes one or more components for imparting antimicrobial properties.

23. The article of claim 1, wherein the article is free of a separate frame assembly.

24. The article of claim 1, wherein a frame is formed to seal the article by hot compressing edges of the article and positioning the edges to form side walls.

25. The article of claim 1, wherein the article has a density gradient from one surface toward an opposing surface, and wherein larger particles are trapped at the one surface and smaller particles are trapped toward the opposing surface.

26. The article of claim 1, wherein the article provides filtration without electrostatic charging.

27.-30. (canceled)
